(19) United States
(12) Patent Application Publication
(10) Pub. No.: US 2022/0375210 A1
(43) Pub. Date: Nov. 24, 2022

(54) METHOD FOR CONTROLLING A ROBOTIC DEVICE

(71) Applicant: Robert Bosch GmbH, Stuttgart (DE)

(72) Inventors: Anh Vien Ngo, Nehren (DE); Hanna Ziesche, Leonberg (DE); Zohar Feldman, Haifa (IL); Dotan Di Castro, Haifa (IL)

(21) Appl. No.: 17/661,041

(22) Filed: Apr. 27, 2022

(30) Foreign Application Priority Data
May 12, 2021 (DE) 10 2021 204 846.3

(51) Int. Cl. G06V 10/82; G06V 10/77; G06V 20/50; B25J 9/16; G06N 3/08

(52) U.S. Cl. CPC G06V 10/82; G06V 10/77; G06V 20/50; B25J 9/1697; G06N 3/08; B25J 9/1612; G05B 2219/50391

(57) ABSTRACT

A method for controlling a robotic device. The method includes: obtaining an image, processing the image using a neural convolutional network, which generates an image in a feature space from the image, the image in the feature space, feeding the image in the feature space to a neural actor network, which generates an action parameter image, feeding the image in the feature space and the action parameter image to a neural critic network, which generates an assessment image, which defines for each pixel an assessment for the action defined by the set of action parameter values for that pixel, selecting, from multiple sets of action parameters of the action parameter image, that set of action parameter values having the highest assessment, and controlling the robot for carrying out an action according to the selected action parameter set.

### CROSS REFERENCE

The present applicant claims the benefit under 35 U.S.C. § 119 of German Patent Application No. 10 2021 204 846.3 filed on May 12, 2021, which is expressly incorporated herein by reference in its entirety.

### FIELD

The present description relates to a method for controlling a robotic device.

### BACKGROUND INFORMATION

Picking up an object from an opened container, such as a box or a carton is a frequent task for a robot in the industry, for example, at an assembly line. A fundamental atomic task for the robot in this case is gripping. If gripping is successful, the robot is also able to carry out the more complex manipulation task of picking up from a container (and, if necessary, storing). It is particularly difficult if multiple objects are placed in the container and the robot is to remove all objects from the container and is to place them at a target position. Moreover, numerous other technical challenges may occur which must be overcome, such as noise and obscurations in perception, object obstructions and collisions in the movement planning. Robust methods for controlling a robot for picking up objects from a container are therefore desirable.

### SUMMARY

According to various specific embodiments of the present invention, a method is provided for controlling a robotic device, which includes: obtaining an image of surroundings of the robotic device, processing the image with the aid of a neural convolutional network, which generates an image in a feature space from the image, the image in the feature space including a vector in the feature space for each pixel of at least a subset of the pixels of the image, feeding the image in the feature space to a neural actor network, which generates a map on action parameters from the image in the feature space, the map for each of the pixels including a set of action parameter values for an action of the robotic device, feeding the image in the feature space and the action parameter image to a neural critic network, which generates an assessment image, which defines for each pixel an assessment for the action defined by the set of action parameter values for the pixel, selecting, from multiple sets of action parameters of the action parameter image, that set of action parameter values having the highest assessment and controlling the robot for carrying out an action according to the selected action parameter set.

With the aid of the above control method, a discretization may be prevented from being carried out for continuous parameters of an action of the robotic device (for example, of a robotic skill such as a gripping). This enables calculations and memory efficiency during the training and the generalization of training scenarios to similar scenarios. It also enables the above approach to add parameters for skills or for action primitives and in the process to avoid the ‘curse of dimensionality’ associated with the discretization. This enables the efficient working with actions having a high number of degrees of freedom. In other words, the output of the neural network (on the basis of which the action parameters for the control are selected) scales according to various specific embodiments linearly with the dimensionality of the actions, instead of increasing exponentially, as is typically the case when all parameters are discretized.

The feeding of the image in the feature space and of the action parameter image to the neural critic network may include a pre-processing, in order to adapt the formats of the two images to one another and to link or to combine the two images with one another.

Since the action may be a simple action in the course of a larger task, it is also referred to in the following description as an action primitive.

Various exemplary embodiments of the present invention are disclosed below.

Exemplary embodiment 1 is the above-described method for controlling a robotic device.

Exemplary embodiment 2 is the method according to exemplary embodiment 1, where the robot is controlled to carry out the action at a horizontal position, which is provided by the position of the pixel in the image for which the action parameter image includes the selected set of action parameter values.

A mixture of discrete action parameters (horizontal pixel positions) and continuous action parameters (sets of action parameter values determined by the actor network) is thereby achieved. The “curse of dimensionality” in this case remains limited, since only the position in the plane is discretized.

Exemplary embodiment 3 is the method according to exemplary embodiment 1 or 2, where the image is a depth image and the robot is controlled to carry out the action at a vertical position, which is provided by the depth information of the image for the pixel for which the action parameter image includes the selected set of action parameter values.

Thus, the depth information from the depth image is used directly as an action parameter value and may, for example, indicate at which height a robotic arm with its gripper is to grip.

Exemplary embodiment 4 is the method according to one of exemplary embodiments 1 through 3, where the image shows one or multiple objects, the action being a gripping or a pushing of an object by a robotic arm.

In such a “bin-picking” scenario, in particular, the above-described approach is suitable, since here discrete positions and continuous gripper orientations (and also pushing distances and pushing directions) may be taken.

Exemplary embodiment 5 is the method according to one of exemplary embodiments 1 through 4 including, for each action type of multiple action types,
processing the image with the aid of a neural convolutional network, which generates an image in the feature space from the image, the image in the feature space including a vector in the feature space for each pixel of at least a subset of the pixels of the image;
feeding the image in the feature space to a neural actor network, which generates an action parameter image from the image in the feature space, the action parameter image including for each pixel a set of action parameters for one action of the action type; and
feeding the image in the feature space and the action parameter image to a neural critic network, which generates an assessment image, which includes for each pixel an assessment for the action defined by the set of action parameter values for that pixel; and

selecting, from multiple sets of action parameters of the action parameter images for various of the multiple action types, that set of action parameter values having the highest assessment, and controlling the robot for carrying out an action according to the selected action parameter set and according to the action type for which the action parameter image has been generated, from which the selected action parameter set has been selected.

The control is thus able to efficiently select not only the action parameters for an action type, but also the action type itself to be carried out (for example, gripping or pushing). The neural networks may be different for the different action types, so that they are able to be trained suitable to the respective action type.

Exemplary embodiment 6 is the method according to one of exemplary embodiments 1 through 5, including carrying out the method for multiple images and training the neural convolutional network, the neural actor network, and the neural critic network with the aid of an actor critic reinforcement learning method, each image representing a state and the selected action parameter set representing the action carried out in the state.

The entire neural control network (including the neural convolutional network, the neural actor network, and the neural critic network) may be efficiently trained end-to-end.

Exemplary embodiment 7 is a robot control unit, which implements a neural convolutional network, a neural actor network and a neural critic network and is configured to carry out the method according to one of exemplary embodiments 1 through 6.

Exemplary embodiment 8 is a computer program including commands which, when they are executed by a processor, prompt the processor to carry out a method according to one of exemplary embodiments 1 through 6.

Exemplary embodiment 9 is a computer-readable medium, which stores commands which, when they are executed by a processor, prompt the processor to carry out a method according to one of exemplary embodiments 1 through 6.

### BRIEF DESCRIPTION OF THE DRAWINGS

In the figures, similar reference numerals refer in general to the same parts in the various views. The figures are not necessarily true to scale, the emphasis instead being placed in general on the representation of principles of the present invention. In the following description, various aspects are described with reference to the following drawings.

FIG. 1 shows a robot.

FIG. 2 shows a neural network, with the aid of which according to one specific embodiment the control unit of the robot of FIG. 1 selects a control action based on an RGB-D image.

FIG. 3 shows a flowchart, which represents a method for training a control assembly for a controlled system according to one specific embodiment.

### DETAILED DESCRIPTION OF EXAMPLE EMBODIMENTS

The following detailed description refers to the accompanying drawings which, for the purpose of explanation, show specific details and aspects of this description, in which the present invention may be carried out. Other aspects may be used and structural, logical, and electrical changes may be carried out without departing from the scope of protection of the present invention. The various aspects of this description are not necessarily mutually exclusive, since some aspects of this description may be combined with one or with multiple other aspects of this description in order to form new aspects

Various examples are described in greater detail below.

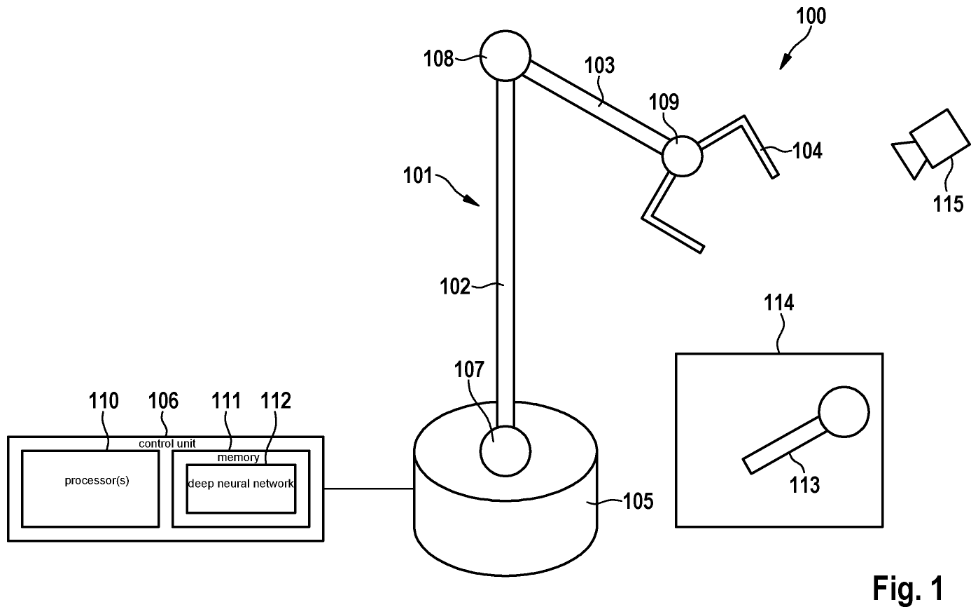

FIG. 1 shows a robot 100.

Robot 100 includes a robotic arm 101, for example an industrial robotic arm, for manipulating or mounting a workpiece (or one or multiple other objects). Robotic arm 101 includes manipulators 102, 103, 104 and a base (or support) 105, with the aid of which manipulators 102, 103, 104 are supported. The term “manipulator” refers to the movable elements of robotic arm 101, the actuation of which enables a physical interaction with the surroundings, for example, in order to carry out a task. For the control, robot 100 includes a (robot) control unit 106, which is configured for the purpose of implementing the interaction with the surroundings according to a control program. Last component 104 (which is furthest away from support 105) of manipulators 102, 103, 104 is also referred to as end effector 104 and may include one or multiple tools such as, for example, a welding torch, a gripping instrument, a painting device or the like.

Other manipulators 102, 103 (closer to base 105) may form a positioning device so that, together with end effector 104, robotic arm 101 is provided with end effector 104 at its end. Robotic arm 101 is a mechanical arm, which is able to fulfill functions similar to a human arm (possibly with a tool at its end).

Robotic arm 101 may include joint elements 107, 108, 109, which connect manipulators 102, 103, 104 to one another and to base 105. A joint element 107, 108, 109 may include one or multiple joints, each of which is able to provide a rotational movement and/or a translational movement (i.e., displacement) of associated manipulators relative to one another. The movement of manipulators 102, 103, 104 may be initiated with the aid of actuators, which are controlled by control unit 106.

The term “actuator” may be understood to mean a component, which is designed to influence a mechanism or process in response to its drive. The actuator is able to convert commands, which are output by control unit 106 (the so-called activation) into mechanical movements. The actuator, for example, an electromechanical converter, may be designed to convert electrical energy into mechanical energy in response to its activation.

The term “control unit” may be understood to mean any type of logic that implements an entity, which may include, for example, a circuit and/or a processor, which is/are able to execute a software, which is stored in a memory medium, firmware or a combination thereof, and is able, for example, to output the commands, for example, to an actuator in the present example. The control unit may, for example, be configured by a program code (for example, software) in order to control the operation of a robot.

In the present example, control unit 106 includes one or multiple processors 110 and one memory 111, which stores code and data, according to which processor 110 controls robotic arm 101.

Robot 100 is intended, for example, to pick up an object 113. For example, end effector 104 is a gripper and is intended to pick up object 113; however, end effector 104 may also be configured, for example, to use suction to pick up object 113. Object 113 is located, for example, in a container 114, for example, in a box or in a carton.

Picking up object 113 is particularly difficult when the object is situated close to a wall or even in a corner of the container. If object 113 lies close to a wall or in the corner, end effector 104 is unable to pick up the object from arbitrary directions. Object 113 may also lie close to other objects, so that end effector 104 is unable to arbitrarily pick up object 113. In such cases, the robot may initially shift, for example, push object 113 into the center of container 114.

According to various specific embodiments, robotic arm 101 is controlled for picking up an object using two continuously parameterized action primitives, a gripping primitive and a pushing primitive. Values for the parameters that define the action primitives are provided as output of a deep neural network 112. The control method may be trained end-to-end

For gripping, a parameterization including two discrete parameters (2D-position in the x-y plane of an RGB-D image) and three continuous parameters (yawing, pitching of the end effector and gripper opening) is used, whereas for pushing, a parameterization including two discrete parameters (2D-position in the x-y plane of an RGB-D image) and five continuous parameters (yawing, inclining, rolling of the end effector as well as pushing direction and pushing distance) is used.

Although discrete and continuous parameters are used, a hybrid formulation is avoided. In contrast, since the continuous parameters are a function of the selection of the discrete parameters, a hierarchical reinforcing learning (RL for Reinforcement Learning) and a hierarchical control strategy optimization are used.

According to various specific embodiments, soft actor critic (SAC) is used as the underlying RL method.

SAC is an off-policy actor-critic method, in which together a pair of statement action value functions Q_{ϕ}^{π}, i =1,2 and a stochastic control strategy πθ are trained. Since SAC follows the paradigm of the maximum entropy RL, the actor is trained in order to maximize the cumulative expected usage and its entropy, so that it acts as randomly as possible. In the standard SAC, the actor is parameterized as a Gaussian control strategy π_{θ} and is trained using the following target function:

$$ℒ ( θ ) = {{𝔼}_{a}}_{∼ {π}_{θ}} [ {Q}^{π} ( s , a ) - α log {π}_{θ} ( a \vert s ) ] , \\ where {Q}^{π} ( s , a ) = {min}_{i = 1 , 2} {Q}_{{ϕ}_{i}}^{π} ( s , a )$$

The critics Q_{ϕ}_{ᵢ} are trained with the aid of deep Q-learning, the targets being provided by associated, temporally delayed target networks Q_{ϕ̅}_{ᵢ}, i.e., the critic loss is provided by

$$ℒ ( {ϕ}_{i} ) = {𝔼}_{s , a , {s}^{′} , r ∼ 𝒟 , {a}^{′} ∼ {π}_{θ}} [ {( {Q}_{{ϕ}_{i}} ( s , a ) - ( r + γ yt ( {s}^{′} , {a}^{′} ) ) )}^{2} ] \\ where {y}_{t} ( {s}^{′} {a}^{′} ) is defined as \\ {y}_{t} ( {s}^{′} {a}^{′} ) = ( {min}_{i = 1 , 2} {Q}_{{ϕ}_{i}}^{-} ( {s}^{′} , {a}^{′} ) - α log {π}_{θ} ( {a}^{′} \vert {s}^{′} ) )$$

Here, states s, actions a, next states s′ and rewards are sampled from a repetition memory, which is continuously filled during the course of training. Action a′ in state s′ is sampled from the instantaneous control strategy. Hyperparameter α, which controls the entropy, may be automatically adjusted.

According to various specific embodiments, the actions that are carried out by the robot are ascertained based on RGB-D images.

Deep RL methods on high-dimensional input spaces such as, for example, images, are known to suffer from a poor sampling efficiency. For this reason, according to various specific embodiments, representations (in a feature space) are learned, contrastive learning being used.

Contrastive learning is based on the idea that similar inputs are mapped onto points (representations) qᵢ, which are situated close together in the feature space, whereas representations of inputs that are not similar should be situated further apart.

The proximity of two embeddings (i.e., representations) is measured by an assessment function f(qᵢ;qⱼ). This is, for example, the scalar product qᵢ^{T}·qⱼ or another bilinear linkage qᵢ^{T}W_{qj} of the two embeddings.

In order to facilitate the learning of a mapping of inputs onto representations with this characteristic, ‘noise contrastive estimation’ (NCE) and a so-called InfoNCE loss are used in contrastive methods provided by

$${ℒ}_{c} = - log \frac{exp ( {q}^{T} W {q}^{pos} )}{exp ( {\sum }_{j = 0}^{N} exp ( {q}^{T} W {q}_{j}^{neg} )}$$

In this case, q^{pos} refers to the representation of a positive example, which is intended to be similar to the instantaneously considered representation q and is often constructed from q by data augmentation of the corresponding input. qⱼ^{neg} refers to the representation of a negative example, which is usually selected as a representation of a random other input. When using minibatches, all other samples of the instantaneous minibatch may, as the negative examples, be selected as the instantaneously considered embedding (i.e., representation).

In the following exemplary embodiment, robot 100 is to pick up object 113 from container 114. This task is modelled as a Markov decision process with a finite time horizon, i.e. by a tuple (S, [symbol] , r ,γ, H ), with state space S, action space [symbol] , transition probability function [symbol] , reward function r, discounting factor Υ, and time horizon with H time steps. In each time step t=1, . . . , H, the control unit observes a state Sₜ∈S (with the aid of sensor data, in particular, images of a camera 115, which may also be fastened at robotic arm 101) and selects according to a control strategy π(aₜ|sₜ) (which is implemented partially by neural network 112) an action aₜ∈ [symbol] . The application of action aₜ in state Sₜ results in a reward r (sₜ,aₜ) and the control system switches (here robotic arm 101) according to [symbol] into a new state Sₜ+1.

State Sₜ is represented as an RGB-D image including four channels, color (RGB) and height (Z). Control unit 106 ascertains the RGB-D image from an RGB-D image provided by camera 115 from the area, in which robotic arm 101 and container 114 are placed. Using the intrinsic and extrinsic camera parameters, the control unit transforms the image into an RGB point cloud in the coordinate system of robotic arm 101, the origin of which is placed, for example, expediently in the center of base 105 and the z-axis pointing upward (in the direction opposite the force of gravity). The control unit then projects the point cloud orthogonally onto a 2-dimensional grid (for example, with a granularity of 5 mm×5 mm) in the xy-plane on which the container is located, to generate the RGB-D image.

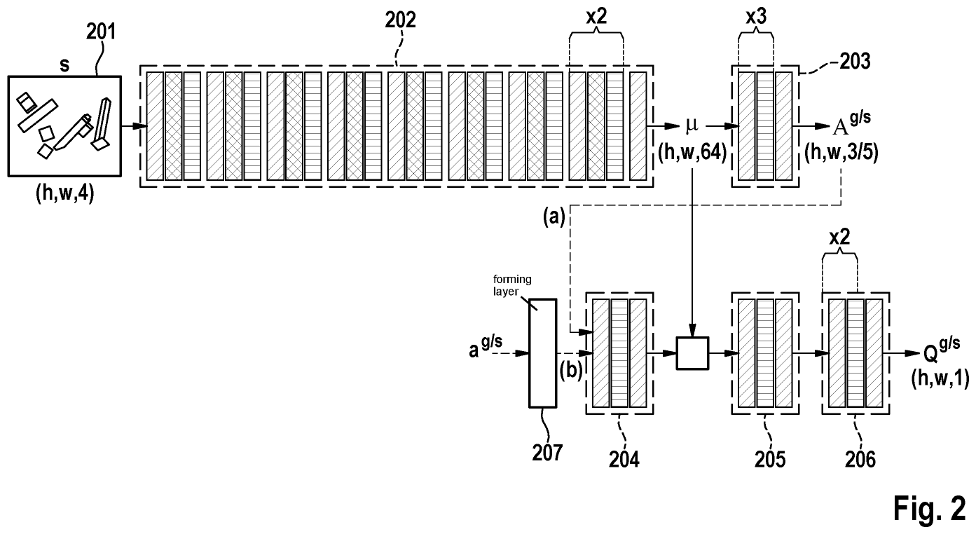

FIG. 2 shows a neural network 200, with the aid of which control unit 106 selects a control action based on a RGB-D image 201.

Convolutional layers with ascending diagonals are shown crosshatched in FIG. 2, ReLu layers are shown horizontally crosshatched and batch normalization layers are shown diagonally crosshatched. If it is indicated that a group of layers occurs multiple times in succession (“x2” or “x3”), then this means that the layers having the same dimensions occur multiple times, whereas the dimensions of the layers otherwise generally change (in particular from convolutional layer to convolutional layer).

Each action aₜ is an action primitive (or assessment primitive) as described above, i.e. a gripping primitive or a pushing primitive, defined by a respective set of parameter values. Reward rₜ, which is maintained in the t-th time step, is 1 if action aₜ results in robotic arm 101 successfully gripping object 113, otherwise it is 0.

Control strategy π(aₜ|sₜ) is trained with the aid of reinforcement learning, in order to maximize Q-function, which is defined by

$$Q ( {s}_{t} , {a}_{t} ) {=}^{△} 𝔼 [ {\sum }_{i = t}^{H} {γ}^{i} r ( {s}_{i} , {a}_{i} ) ]$$

The Bellman equation

$${Q}_{t} ( {s}_{t} , {a}_{t} ) = 𝔼 [ r ( {s}_{t} , {a}_{t} ) + {max}_{{a}_{t + 1}} {Q}_{t + 1} ( {s}_{t + 1} , {a}_{t + 1} ) ]$$

is one possibility of calculating the Q-function recursively and, according to various specific embodiments, it is the basis of the RL method used.

Control strategy π(aₜ|sₜ) outputs in each step the type of action primitive ϕ∈{g (ripping), s (pushing)} as well as the parameter value set for the respective action primitive. The type and the parameter value set define the action intended to be carried out by robotic arm 101. The execution of an action primitive is controlled as follows.

Gripping: the center of end effector 104 (here specifically a gripper, however, an end effector may also be used, which picks up objects using suction), also referred to as TCP (tool center point), is moved from above downward into a target pose, which is defined by the Cartesian coordinates (x^{g}, y^{g}, z^{g}) and the Euler angle (i^{g}, j^{g}, k^{g}), the distance between the gripper fingers being set to w^{g}.

If the target pose has been achieved or a collision has been recognized, the gripper is opened and raised (for example) by 20 cm, whereupon the gripper is signaled again to close. The gripping is considered successful if the read off distance between the fingers exceeds a threshold value, which is greater than a value, which is somewhat below the smallest dimension of the considered objects. For the gripping primitive, the parameter set a^{g}=(x^{g}, [symbol] ^{g}, j^{g}, k^{g}, w^{g}) contains the aforementioned parameters except for Z^{g,} which control unit 106 extracts directly from the RGB-D image at position (x^{g}, [symbol] ^{g}), and the roll angle i^{g}, which is set to 0, in order to ensure that the fingers are all situated at the same height in order to be able to grip from above in a stable manner. Rolling in the example of FIG. 1 is a rotation about an axis by 109 in FIG. 1, the axis emerging from the paper plane.

Pushing: the TCP is moved with closed gripper into a target pose (x^{s}, [symbol] ^{s}, z^{s}, i^{s}, j^{s}, k^{s}, d^{s}, k^{s}), thereafter it is moved by d⁸ in the horizontal direction, which is defined by a rotation angle k^{s} around the z-axis. The parameter set in this case is a^{s}=(x^{s}, [symbol] ^{s}, i^{s}, j^{s}, k^{s}, d^{s}, k^{s}) as with the gripping primitive, control unit 106 extracting parameter Z^{g} from the RGB-D image.

Neural network 200 according to various specific embodiments is a “fully convolutional” network (FCN) ψ^{ϕ} for ascertaining parameter value set a^{ϕ} and for approximating value Q^{ϕ}(s,a^{ϕ}) for each action primitive type ϕ for RGB-D image 201. The underlying algorithm and the architecture of neural network 200 may be viewed as a combination of SAC for continuous actions and Q-learning for discrete actions: for each pixel of the RGB-D image, a first convolutional (sub) network 202, referred to as pixel encoder, ascertains a representation, identified with μ (for example, a vector including 64 components, which pixel encoder 202 ascertains for each pixel of the RGB-D image, i.e. for h x w pixels). On pixel embeddings μ for the RGB D image, further convolutional (sub) networks 203, 204, 205, 206 are applied to the output of pixel encoder 202 and generate an action map (identified with A) per action primitive type and a Q-value map per action primitive type, each of which has the same spatial dimensions h and w (height and width) of RGB-D image 201. These convolutional (sub) networks 203, 204, 205, 206 are an actor network 203, an action encoder network 204, a pixel action encoder network 205 and a critic network 206.

Actor network 203 receives pixel embeddings μ as input and assigns the pixels of the action map pixel values in such a way that the selection of a pixel of the action map provides a complete parameter value set α^{ϕ} (for the respective action primitive type). In the process, control unit 106 derives the values of spatial parameters (x^{ϕ}, y^{ϕ}) from the pixel position (which according to the RGB-D image correspond to a position in the x-y plane). The values of the other parameters are provided by the pixel values of the action map at the pixel position (i.e. by the values of the channels of the action map at the pixel positions). Similarly, the pixel value of the Q-value map (for the respective action primitive type) at the pixel position provides the Q-value for the state-action pair (s, a^{ϕ}). The Q-value thus represents) Q^{ϕ}(s,a^{ϕ}) for a discrete set of actions corresponding to the pixels of the RGB-D image and may accordingly be trained for discrete actions using a Q-learning scheme.

Actor network 203 ascertains, for example, a Gaussian distributed action (as in SAC) for each pixel (with a number of output channels corresponding to the number of parameters of the respective action primitive).

Pixel action encoder 205 codes pairs made up of pixels and actions, each action (i.e., the pixel values from the action map) initially being processed by action encoder network 204 (see path (a) in FIG. 2) and then being concatenated with the associated pixel embedding, before this pair is fed to pixel action encoder 205.

Critic network 206 ascertains the Q-value for each pixel action pair. Similar to a SAC implementation, a double Q architecture may be used for this purpose, where the Q-value is taken as the minimum of two Q-maps in order to avoid overestimating.

Control unit 106 ascertains an action in time step t for an RGB-D image sₜ as follows: neural network 200 (which includes a part ψₜ^{ϕ} for both action primitives) is passed through end-to-end, as a result of which action map A^{ϕ}, corresponding to control strategy πₜ(aₜ^{ϕ}|Sₜ), is generated for both primitives and Q-value map Qᵢ^{ϕ}(S_{t,}aₜ^{ϕ}) for both action primitive types. Index t indicates here that the networks and outputs are or may be time-dependent, as is typically the case in Markov decision processes with a finite time horizon.

Control unit 106 selects the action primitive according to

ϕ*=arg max_{ϕ} maxₐ_{ₜ}_{^{ϕ}} Qₜ^{ϕ}(sₜ, aₜ^{ϕ})

and sets the parameters of the action primitive according to

a*ₜ^{ϕ*}=arg maxₐ_{ₜ}_{^{ϕ*}} Qₜ^{ϕ*}(sₜ, aₜ^{ϕ*}).

For the training, control unit 106 collects data, i.e., tuples (sₜ, aₜ, rₜ, sₜ₊₁), from experiments and stores them in a repetition memory. From this, it then selects for training from (path (b) in FIG. 2 for the actions). The actions from the repetition memory are brought into a form suitable for action encoder network 204 by a forming layer 207. When sampling mini-batches from the data for the training, it may use data augmentation in order to increase the sample efficiency. It may, in particular, generate versions for a sampled experience (sₜ, aₜ, rₜ, sₜ₊₁), which are invariant with respect to the task to be learned, in that it rotates the RGB-D image sₜ by a random angle and rotates the relevant angle of the parameter value set of action aₜ by the same angle. For example, the yaw angle for both primitives may be changed and during the pushing primitive, the pushing direction may also be rotated. In this way, the control unit may generate for a training sample (from the repetition memory) an additional training sample, which should lead to a similar result rₜ and sₜ₊₁ as the original training sample.

Control unit 106 trains the neural network using the following loss functions or target functions.

Critic loss:

$${ℒ}_{critic} = \{ \begin{matrix}BCE ( {Q}_{i}^{ϕ} ( {s}_{t} , {a}_{t}^{ϕ} ) , {y}_{t} ) & t = H \\ MSE ( {Q}_{i}^{ϕ} ( {s}_{t} , {a}_{t}^{ϕ} ) , {y}_{t} ) & otherwise\end{matrix}$$

where BCE (binary cross entropy) stands for the binary cross entropy loss and MSE (mean squared error) stands for the mean squared error loss and

$${y}_{t} = {r}_{t} + γ {max}_{ϕ , a} {Q}_{t + 1}^{ϕ} ( {s}_{t} , a )$$

The network parameters of pixel encoder network 202, of pixel action encoder network 205 and of critic network 206 are trained to maximize (or to reduce) the critic loss.

Actor target function:

[symbol]

actor=Qₜ^{ϕ}(sₜ, aₜ^{ϕ})−α log πₜ^{ϕ}(aₜ^{ϕ}|sₜ)

The network parameters of pixel encoder network 202, and of actor network 203 are trained to minimize (or to increase) the actor target function.

As explained above, control unit 106 is able to apply data augmentation to training samples by changing the state (RGB-D image) and correspondingly adapting the associated action. Ideally, the pixel embeddings for augmentations (or versions) of the same sample generated by pixel encoder 202 are more similar to one another than for different samples (i.e., those in which one is not the augmentation of the other). In order to facilitate this during the training of the pixel action encoder, a contrastive loss may be used as an additional loss term.

For this purpose, control unit 106 generates, for example, for a sample in the mini-batch, two augmentations and codes these with the aid of pixel encoder 202 to a query embedding q or to a key embedding k. It then calculates the similarity between q and k via the bilinear link sim(k,q)=k^{T}Wq, w being a parameter matrix (which may itself be learned). A contrastive loss, which is a function of the similarities as they are provided by the function sim(.), and of the information about which samples are augmentations of the same sample and thus should have a high degree of similarity, may then [sic].

In MDPs with a finite time horizon, the Q-function is time-dependent and accordingly, it is meaningful to approximate the Q-functions in the various time steps via different networks. However, this requires the training of H neural networks, which may mean a high computing effort.

This problem may be avoided by treating the MDP as an MDP with an infinite time horizon, regardless of the actual model, and by using a discounting factor in order to mitigate the effect of future steps. According to one specific embodiment, different networks for the different time steps are used instead and different weakening measures are taken. For example, a fixed and small time horizon of H=2 is used, regardless of the number of time steps that are allowed in order to empty container 114. This choice helps to reduce the aforementioned hurdles, which are reinforced still further as a result of a large action space and as a result of the fact that rewards occur only very rarely at the beginning of the training. It may also be motivated by the observation that the control for picking up from a container typically does not profit from looking ahead by more than a few steps. In fact, looking ahead beyond the present state is advantageous particularly when a shift is required in order to enable a subsequent gripping and, in this case, one single shift is most likely sufficient.

In accordance with this weakening, the control unit according to one specific embodiment uses a neural network ψ₀, in order to derive an action in the step t=0, and a neural network ψ₁ for t=1.

During the training, control unit 106 is able to use all recorded experiences for updating the neural networks for all time steps, regardless of for which time step within the episode they actually occurred.

According to various specific embodiments, control unit 106 uses an exploration heuristic. In order to increase the chances for a successful result of a gripping action or a pushing action during exploration steps, the control unit uses a method for recognizing changes, in order to localize pixels that correspond to objects. For this purpose, it compares the point cloud of the present state from a reference point cloud of an image with an empty container and masks the pixels, in which there is a sufficient difference. It then samples an exploration action from these masked pixels according to a uniform distribution.

The control unit also has a bounding box of container 114 (this may be known or the control unit may obtain it by using a recognition tool). Points may then be defined on end effector 104 (including, for example, a camera fastened at the robot), which control unit 105 transforms in accordance with a target pose in order to check its feasibility, in that it checks whether the transformed points are situated within the bounding box of container 114. If there is at least one point that is situated outside container 114, the attempt is abandoned, since it would result in a collision. Control unit 106 is also able to use this calculation as additional exploration heuristics for the search for a feasible orientation for a given translation, by selecting from a random set of orientations one that is feasible, if such a one exists.

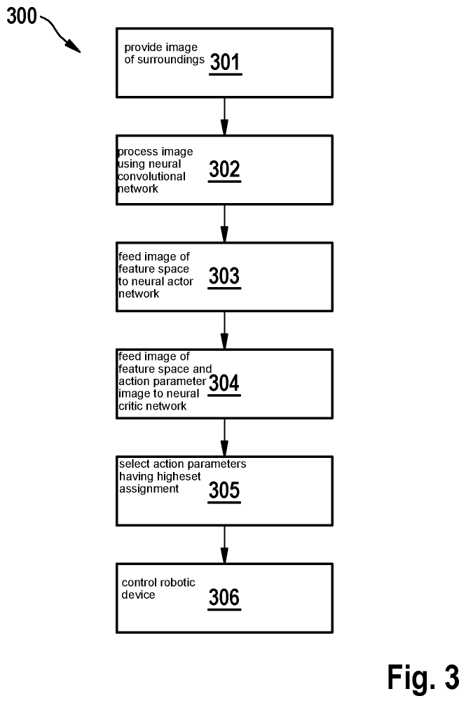

In summary, according to various specific embodiments, a method is provided as it is represented in FIG. 3.

FIG. 3 shows a flowchart 300, which illustrates a method for controlling a robotic device.

In 301, an image of surroundings of the robotic device is provided, (for example, recorded by a camera).

In 302, the image is processed with the aid of a neural convolutional network, which generates an image in a feature space from the image, the image in the feature space including a vector in the feature space for each pixel of at least a subset of the pixels of the image.

In 303, the image in the feature space is fed to a neural actor network, which generates an action parameter image from the image in the feature space, the action parameter image including for each of the pixels a set of action parameter values for an action of the robotic device.

In 304, the image in the feature space and the action parameter image are fed to a neural critic network, which generates an assessment image, which includes for each pixel an assessment for the action defined by the set of action parameter values for that pixel.

In 305, the set of action parameters having the highest assessment is selected from multiple sets of action parameters of the action parameter image.

In 306, the robotic device is controlled for carrying out an action according to the selected action parameter set.

The method of FIG. 3 may be carried out by one or by multiple computers with one or with multiple data processing units. The term “data processing unit” may be understood to be any type of entity that enables the processing of data or of signals. The data or signals may be handled, for example, according to at least one (i.e., one or more than one) specific function, which is carried out by the data processing unit. A data processing unit may include or be designed from an analog circuit, a digital circuit, a logic circuit, a microprocessor, a microcontroller, a central unit (CPU), a graph processing unit (GPU), a digital signal processor (DSP), an integrated circuit of a programmable gate array (FPGA) or any combination thereof. Any other manner for implementing the respective functions, which are described in greater detail herein, may also be understood as a data processing unit or logic circuit array. One or multiple of the method steps described in detail herein may be carried out (for example, implemented) by a data processing unit via one or multiple specific functions, which are carried out by the data processing unit.

The approach of FIG. 3 is used to generate a control signal for a robotic device. The term “robotic device” may be understood as referring to any physical system (including a mechanical part, whose movement is controlled), such as, for example, a computer-controlled machine, a vehicle, a household appliance, a power tool, a manufacturing machine, a personal assistant or an access control system. A control rule for the physical system is learned and the physical system is then controlled accordingly.

Various specific embodiments may receive and use sensor signals from various sensors such as, for example, video, radar, LIDAR, ultrasound, movement, heat mapping, etc., for example, in order to obtain sensor data with respect to states of the system (robot and object or objects) and configurations and control scenarios. Specific embodiments may be used for training a machine learning system and for controlling a robotic device, for example, in order to carry out various manipulation tasks in various control scenarios.

Although specific embodiments have been represented and described herein, those skilled in the art will recognize that the specific embodiments shown and described may be replaced by a variety of alternative and/or equivalent implementations without departing from the scope of protection of the present invention. This application is intended to cover any adaptations or variations of the specific embodiments discussed herein.

What is claimed is:

1. A method for controlling a robotic device, comprising:
obtaining an image of surroundings of the robotic device;
processing the image using a neural convolutional network, which generates an image in a feature space from the image, the image in the feature space including a vector in the feature space for each pixel of at least a subset of pixels of the image;
feeding the image in the feature space to a neural actor network, which generates an action parameter image from the image in the feature space, the action parameter image for each of the pixels including a set of action parameter values for an action of the robotic device;
feeding the image in the feature space and the action parameter image to a neural critic network, which generates an assessment image, which defines for each pixel an assessment for the action defined by the set of action parameter values for that pixel;
selecting, from multiple sets of action parameters of the action parameter image, that set of action parameter values having the highest assessment; and
controlling the robot for carrying out an action according to the selected action parameter set.

2. The method as recited in claim 1, wherein the robot is controlled to carry out the action at a horizontal position, which is provided by a position of the pixel in the image, for which the action parameter image includes the selected set of action parameter values.

3. The method as recited in claim 1, wherein the image is a depth image and the robot is controlled to carry out the action at a vertical position, which is provided by depth information of the image for that pixel, for which the action parameter image includes the selected set of action parameter values.

4. The method as recited in claim 1, wherein the image shows one or multiple objects, the action being a gripping or a pushing of an object of the one or multiple objects by a robotic arm.

5. The method as recited in claim 1, further comprising, for each action type of multiple action types:
processing the image using a neural convolutional network, which generates an image in the feature space from the image, the image in the feature space including a vector in the feature space for each pixel of at least a subset of pixels of the image,
feeding the image in the feature space to a neural actor network, which generates an action parameter image from the image in the feature space, the action parameter image including for each pixel a set of action parameters for one action of the action type, and
feeding the image in the feature space and the action parameter image to the neural critic network, which generates an assessment image, which includes for each pixel an assessment for the action defined by the set of action parameter values for that pixel;
selecting, from multiple sets of action parameters of the action parameter images for various of the multiple action types, that set of action parameter values having the highest assessment; and
controlling the robot for carrying out an action according to the selected action parameter set and according to the action type for which the action parameter image has been generated, from which the selected action parameter set has been selected.

6. The method as recited in claim 5, further comprising carrying out the method for multiple images and training the neural convolutional network, the neural actor network, and the neural critic network with the aid of an actor critic reinforcement learning method, each image representing a state and the selected action parameter set representing the action carried out in that state.

7. A robot control unit, which implements a neural convolutional network, a neural actor network, and a neural critic network and is configured to
obtain an image of surroundings of the robotic device;
process the image using the neural convolutional network, which generates an image in a feature space from the image, the image in the feature space including a vector in the feature space for each pixel of at least a subset of pixels of the image;
feed the image in the feature space to the neural actor network, which generates an action parameter image from the image in the feature space, the action parameter image for each of the pixels including a set of action parameter values for an action of the robotic device;
feed the image in the feature space and the action parameter image to the neural critic network, which generates an assessment image, which defines for each pixel an assessment for the action defined by the set of action parameter values for that pixel;
select, from multiple sets of action parameters of the action parameter image, that set of action parameter values having the highest assessment; and
control the robot for carrying out an action according to the selected action parameter set.

8. A non-transitory computer-readable medium on which is stored a computer program for controlling a robotic device, the computer program, when executed by a processor, causing the processor to perform the following steps:
obtaining an image of surroundings of the robotic device;
processing the image using a neural convolutional network, which generates an image in a feature space from the image, the image in the feature space including a vector in the feature space for each pixel of at least a subset of pixels of the image;
feeding the image in the feature space to a neural actor network, which generates an action parameter image from the image in the feature space, the action parameter image for each of the pixels including a set of action parameter values for an action of the robotic device;
feeding the image in the feature space and the action parameter image to a neural critic network, which generates an assessment image, which defines for each pixel an assessment for the action defined by the set of action parameter values for that pixel;
selecting, from multiple sets of action parameters of the action parameter image, that set of action parameter values having the highest assessment; and
controlling the robot for carrying out an action according to the selected action parameter set.
